(19) United States
(12) Patent Application Publication
(10) Pub. No.: US 2014/0308496 A1
(43) Pub. Date: Oct. 16, 2014

(54) MULTILAYER FILMS WITH IMPROVED OPACITY AND STRENGTH

(71) Applicant: Dow Global Technologies LLC, Midland, MI (US)

(72) Inventor: Ayush A. Bafna, Manvel, TX (US)

(73) Assignee: Dow Global Technologies LLC, Midland, MI (US)

(21) Appl. No.: 13/859,772

(22) Filed: Apr. 10, 2013

(51) Int. Cl. B32B 7/02; B32B 5/18

(52) U.S. Cl. CPC B32B 7/02; B32B 5/18
USPC 428/218

(57) ABSTRACT

The present disclosure relates to multilayer thermoplastic films particularly suited for use in liners. The films contain organic voiding agents to produce opacity when stretched while maintaining an MD Tear Strength of at least 150 gm/mil and a Dart Impact of at least 150 gm/mil. Such performance can be maintained by selection and amounts of resins, organic voiding agents and processing conditions of the films.

The present disclosure relates to multilayer thermoplastic films particularly suited for use in liners. The films contain organic voiding agents to produce opacity when stretched while maintaining an MD Tear Strength of at least 150 gm/mil and a Dart Impact of at least 150 gm/mil. Such performance can be maintained by selection and amounts of resins, organic voiding agents and processing conditions of the films.

### BACKGROUND AND SUMMARY OF THE INVENTION

It is desirable for plastic liners, particularly those used to contain bulk waste materials, to be resistant to damage by slow puncture and sudden impact, resistant to tear propagation and failing under stress. Films with high strength characteristics, including dart impact resistance, ultimate tensile strength, tear resistance and puncture toughness, are needed in such applications. Additionally, thin films that exhibit high strength requirements provide a better cost-performance relationship for the consumer. Currently, such liners are most commonly produced from polyolefin films, including polyethylene films.

For many years, high performance polyolefins, such as low density polyethylene (LDPE), have been readily available at a low manufacturing cost sufficient to justify commercial use in trash bags, including heavy duty garbage bags, leaf bags and trash can liners. The use of polyethylene, more particularly low density polyethylene, allows for the production of liners with remarkably thin gauge and flexibility while maintaining descent strength characteristics.

More recently, linear low density polyethylene (LLDPE) has been used in place of conventional highly branched LDPE in many film applications, including bags or liners. LLDPE is widely recognized as being tougher and stronger than LDPE, thus contributing to reduced bag failures, including punctures and splitting. Also, LLDPEs made with metallocene or single site catalysts have been used to provide improved toughness.

Although these liners have proven successful with the consumers, as the down gauging of the films increases, the films become more transparent. This is particularly true when the liner becomes locally stretched, either during use, or intentionally through a local stretching or embossing step which may be used to add certain end use functionality to the bag. It is desired to produce liners having good physical properties at thin gauge, but which remain more opaque even if stretched. Use of inorganic fillers like calcium carbonate or clay can allow improvement in opacity on stretching but at a cost of significant deterioration in film performance, especially tear resistance, ultimate tensile strength and dart impact resistance.

The present invention achieves this goal by providing a multilayer blown film which includes a first layer comprising a first polymer and at least one organic voiding agent, said first polymer comprising a polyethylene polymer having a density less than 0.940 g/cm³ and a melting point less than 130° C. The multilayer blown film also includes a second layer which is different than the first layer, said second layer comprising a second polymer, said second polymer comprising a polyethylene polymer having a density less than 0.940 g/cm³ and a melting point less than 130° C., wherein said second layer has less than 15% organic voiding agent, by weight of the second layer. The film is stretched in the machine direction or the transverse direction or both, so that voids are present in at least the first layer. The films can be characterized by having an MD Tear Strength of at least 200 gm and a Dart Impact of at least 200 gm.

### DETAILED DESCRIPTION OF INVENTION

The present invention relates to certain film structures having improved properties. Films according to this invention provide improved dart impact resistance, MD tear resistance and ultimate tensile strength, low manufacturing costs and remain relatively opaque even when stretched. Such films are ideally suited for use in trash bag or trash liner applications.

The films of the present invention comprise a first layer and a second layer which is different from the first layer. The first layer comprises a first polymer and at least one organic voiding agent, said first polymer comprising a polyethylene polymer having a density less than 0.940 g/cm³ and a melting point less than 130° C. The second layer comprises a second polymer and optionally some organic voiding agent, the second polymer comprising a polyethylene polymer having a density less than 0.940 g/cm³ and a melting point less than 130° C., wherein said second layer has less than 15% voiding agent, by weight of the second layer. The film will comprise voids or cavities in each layer where voiding agents are present. The films of the present invention can be characterized by having an MD Tear Strength of at least 150 gm/mil and a Dart Impact of at least 150 gm/mil.

The first polymer for use in the present invention is an ethylene copolymer. Preferred ethylene copolymers are derived from units of ethylene and at least one C₃ to C₂₀ alpha-olefin comonomer. More preferably, the alpha-olefin comonomer comprises butene, hexene, octene or pentene. In some embodiments of this invention, the ethylene copolymer may be selected from the group consisting of LLDPE, very low density polyethylene (VLDPE), elastomers and plastomers. The ethylene copolymer may be prepared using any catalyst known in the art, including heterogeneous Zeigler-Natta catalyst or homogeneous single site or metallocene catalysts. Blends of two or more different ethylene copolymers are also contemplated.

The first polymer should have a density, as determined by ASTM D792, equal to or less than 0.940 g/cm³. More preferably, the density of the ethylene copolymer is equal to or less than 0.935 g/cm³, more preferably equal to or less than 0.930 g/cm³, and even more preferably less than or equal to 0.927 g/cm³. The density of the first polymer is preferably greater than or equal to 0.910 g/cm³, more preferably, greater than or equal to 0.912 g/cm³, more preferably greater than or equal 0.915 g/cm³, and even more preferably greater than or equal to 0.917 g/cm³. Further, in preferred embodiments of this invention, the ethylene copolymer has a Melt Index (as determined by ASTM D1238: 1999 190° C., 2.16 kg) ranging from 0.1 g/10 min to 5.0 g/10 min. The first polymer also has a melting point (as determined by ASTM D3418-03) less than or equal to 130° C., more preferably less than or equal to 125° C.

Examples of suitable second polymer are DOWLEX™ 2285G, 2085G, 2045G, 2049G, 2038.68G, ATTANE™ 4201, 4203, 4703 and 4202 (all commercially available from The Dow Chemical Company of Midland, Mich.), LL1001, LL1002, LL2001, LL3002 and LL3003.32 (commercially available from ExxonMobil Chemical Company of Baytown, Tex.). Examples of suitable mLLDPEs and mVLDPEs are ELITE™ 5400G, 5100G and 5111G (all commercially available from The Dow Chemical Company of Midland, Mich.), EXCEED™ 1012, 1018 and 2018 metallocene polyethylenes (commercially available from ExxonMobil Chemical Company of Baytown, Tex.). And, examples of suitable plastomers and elastomers are ENGAGE™ thermoplastic polyolefin elastomers and AFFINITY™ polyolefin plastomers (both commercially available from The Dow Chemical Company of Midland, Mich.), EXACT™; 5361, 4049, 5371, 8201, 4150, 5181, 3132 ethylene plastomers (commercially available from ExxonMobil Chemical Company of Baytown, Tex.).

The first layer further comprises organic voiding agents which may also be referred to as cavitating agents. The organic voiding agents may be present such that the total amount of voiding agents in the whole film is from 1 to 20% by weight. In some embodiments, the voiding agent is present in the first layer in an amount ranging from 1 wt % to 20 wt %, preferably from 1.5 wt % to 15 wt %, more preferably from 1.5% to 10% and more preferably from 2% to 5%. Voiding agents may include any suitable organic particulate material that is incompatible with the polymer material(s) of the first layer so that, upon stretching of the film during orientation, voids form around some or all of the voiding agent particles. These voids are important for improving or maintaining the film's opacity when stretched thin. The voids may also impart a pearlescent appearance and “soft touch” tactile characteristics to the film, which are also desirable for consumers. The voiding agent(s) may, for example, be any of those described in U.S. Pat. Nos. 4,377,616, 4,632,869 and 5,691,043, the entire disclosures of which are incorporated herein by reference. Specific examples of suitable organic cavitating or voiding agents for use in the present invention are polyamides, polyesters, acetals, nylons, acrylic resins, cyclo-olefin polymers and copolymers, polybutylene terephthalate, nylon, polystyrene, high impact polystyrene, acrylic beads, crosslinked acrylic beads, hollow acrylic beads, crosslinked styrenic beads, and combinations thereof. In some embodiments, it may be preferred that the voiding agent comprises an organic material, with polystyrene, high impact polystyrene, acrylic beads, crosslinked acrylic beads, hollow acrylic beads, crosslinked styrenic beads, polyamide and cyclic olefin copolymers being particularly preferred for some applications.

The particle size d50, of the filler particles when dispersed in the polyethylene matrix typically may be from 0.1 μm to 10 μm, preferably from 0.5 μm to 5 μm, more preferably from 0.7 μm to 2.5 μm. The particle size d90 of the filler particles when dispersed in the polyethylene matrix will be less than 5 times its d50. For example, if a particle type with d50 of 2 μm is used, this particle would have a d90 of less than 20 μm.

Particle Size d50 is also known as the median diameter or the medium value of the particle size distribution, it is the value of the particle diameter at 50% in the cumulative distribution. It is one of an important parameter characterizing particle size. For example, if d50=2.0 μm, then 50% of the particles in the sample are smaller than 2.0 μm, and 50% larger than 2.0 μm. d50 is usually used to represent the particle size of group of particles. d90 allows one to understand the amount of large particles in the particle size distribution. For example, if d90=10.0 μm, then 90% of the particles in the sample are smaller than 10.0 μm, and 10% larger than 10.0 μm.

The first layer may advantageously further include a plasticizer. As is known to those skilled in the art, plasticizers are typically used to soften polymer chains, thereby increasing the workability and flexibility of the polymer. Additionally, plasticizers are known to combine with the amorphous regions of LLDPE and extend the degree of polymer chain entanglement, thus increasing the elasticity of the polymer sheet at elevated temperatures. In the current invention, the increased elasticity may contribute to improved processability upon orientation. Plasticizers for use with the current invention include amorphous or semi-crystalline polymers with a melting point less than about 125° C. or processing additives such as white oil. Examples of suitable plasticizers are LDPE, VLDPE, ethylene vinyl acetate (EVA) copolymers, ethylene acrylic acid (EAA) copolymers, ethylene-ethyl acrylate (EEA) copolymers, propylene plastomers and elastomers, ethylene plastomers and elastomers, polyolefin adhesive materials, hydrocarbon and natural resins, waxes (including synthetic, micro-crystalline and paraffinic waxes), poly-alpha-olefins, low melt temperature ethylene polymers or copolymers, ethylene propylene copolymers or terpolymers, or combinations thereof. Commercially available plasticizers that may be suitable for use as described herein include, but are not limited to, VERSIFY™ Plastomer, INFUSE™ Olefin Block Copolymer, ENGAGE™ thermoplastic polyolefin elastomers and AFFINITY™ polyolefin plastomers (all commercially available from The Dow Chemical Company of Midland, Mich.), VISTAMAXX™, EXACT™, ESCORENE™; ULTRA LD-720.92, OPPERA™; PA-851N, PA-702N and ELEVAST™ (all commercially available from ExxonMobil Chemical Company of Baytown, Tex.) and BE SQUARE™; microcrystalline wax (commercially available from Baker Petrolite of Sugarland, Tex.).

In some embodiments of the present invention, plasticizers may be present in the first layer in an amount ranging from 0 wt % to 60 wt %, preferably ranging from 2 wt % to 20 wt %.

The first layer may further comprise one or more additives such as pigments, colorants, slip agents, antiblocks, antioxidants, anti-fog agents, anti-static agents, fillers, moisture barrier additives, gas barrier additives and combinations thereof, as discussed in further detail below. In some preferred embodiments, the multilayer film includes a color pigment. Such pigment can be added directly to the layer or can be added to the voiding agent. For organic voiding agents, the color pigment may advantageously be dispersed in the voiding agent, and for inorganic voiding agents, the color pigment may advantageously coat the voiding agent. Titanium dioxide and carbon black may be preferred color pigments for certain applications.

Preferably, the total amount of additives, including voiding agents, in the first layer ranges from 0.2 wt % to 40.0 wt %, more preferably from 2.0 wt % to 20.0 wt %.

In some embodiments, the first layer has a thickness in the range of from 5 μm to 100 μm, alternatively from 10 μm to 75 μm, or from 12 μm to 50 μm. These thicknesses refer to the layer prior to any post-quench orientation step.

The multilayer films of the present invention further comprise a second layer. The second layer is different than the first layer and is contiguous to a side of the first layer.

The second layer comprises an ethylene copolymer. Preferred ethylene copolymers are derived from units of ethylene and at least one C₃ to C₂₀ alpha-olefin comonomer. More preferably, the alpha-olefin comonomer comprises butene, hexene, octene or pentene. In some embodiments of this invention, the ethylene copolymer may be selected from the group consisting of LLDPE, very low density polyethylene (VLDPE), elastomers and plastomers. The ethylene copolymer may be prepared using any catalyst known in the art, including heterogeneous Zeigler-Natta catalyst or homogeneous single site or metallocene catalysts. Blends of two or more different ethylene copolymers are also contemplated.

The second polymer should have a density, as determined by ASTM D792, equal to or less than 0.940 g/cm³. More preferably, the density of the ethylene copolymer is equal to or less than 0.935 g/cm³, more preferably equal to or less than 0.930 g/cm³, and even more preferably less than or equal to 0.927 g/cm³. The density of the second polymer is preferably greater than or equal to 0.910 g/cm³, more preferably, greater than or equal to 0.912 g/cm³, more preferably greater than or equal 0.915 g/cm³, and even more preferably greater than or equal to 0.917 g/cm³. Further, in preferred embodiments of this invention, the ethylene copolymer for use in the second polymer has a Melt Index (as determined by ASTM D1238: 1999 190° C., 2.16 kg) ranging from 0.1 g/10 min to 5.0 g/10 min. The second polymer also has a melting point (as determined by ASTM D3418-03) less than or equal to 130° C., more preferably less than or equal to 125° C.

The second polymer may advantageously be selected to include a polymer that is suitable for heat-sealing or bonding to itself when crimped between heated crimp-sealer jaws. Generally, lower density polyethylenes tend to have better heat sealing properties, and so it may be preferred that the polyethylene resin used as the second polymer have a density which is less than the density of the polyethylene used as the first polymer, for example at least 0.01 g/cm³ less. The second layer may also increase the impact strength of the overall structure. Generally, polyethylenes with comparatively lower density or narrower molecular weight distribution (for example Mw/Mn less than or equal to 3.5) or higher molecular weight (for example greater than or equal to 80,000 weight average molecular weight) tend to have better impact strength properties. Examples of suitable second polymer are DOWLEX™ 2285G, 2085G, 2045G, 2049G, 2038.68G, ATTANE™ 4201, 4203, 4701, 4703 and 4202 (all commercially available from The Dow Chemical Company of Midland, Mich.), LL1001, LL1002, LL2001, LL3002 and LL3003.32 (commercially available from ExxonMobil Chemical Company of Baytown, Tex.). Examples of suitable mLLDPEs and mVLDPEs are ELITE™ 5400G, 5100G and 5111G (all commercially available from The Dow Chemical Company of Midland, Mich.), EXCEED™ 1012, 1018 and 2018 metallocene polyethylenes (commercially available from ExxonMobil Chemical Company of Baytown, Tex.). And, examples of suitable plastomers and elastomers are ENGAGE™ thermoplastic polyolefin elastomers and AFFINITY™ polyolefin plastomers (both commercially available from The Dow Chemical Company of Midland, Mich.), EXACT™; 5361, 4049, 5371, 8201, 4150, 5181, 3132 ethylene plastomers (commercially available from ExxonMobil Chemical Company of Baytown, Tex.).

The second layer may further comprise voiding agents as described above, but in an amount less than 15% by weight of the second layer, preferably less than 10% by weight of the second layer and more preferably less than 5% by weight of the second layer. In some preferred embodiments, the second layer is substantially free from voiding agents. The second layer may also advantageously contain one or more of plasticizers pigments, colorants, slip agents, antioxidants, anti-fog agents, anti-static agents, fillers, moisture barrier additives, gas barrier additives and combinations thereof, as discussed in further detail below.

In some embodiments, the second layer has a thickness in the range of from 2 μm to 50 μm, alternatively from 3 μm to 25 μm, or from 4 μm to 15 μm. These thicknesses refer to the layer prior to any post-quench orientation step.

The multilayer films of the present invention may include further layers. Such layers may provide additional functionality, but must be chosen so as to be compatible with the other film layers and so as not to detrimentally affect the overall film properties. If additional layers are present it may be preferred to arrange the layers such that the first layer is not a surface layer. In preferred embodiments the overall multilayer film structure has an overall thickness prior to post-quench stretching greater than or equal to 12 μm, 15 μm, or 20 μm (approximately 0.5, 0.7 or 0.8 mils) and less than or equal to 125 μm, 75 μm, or 50 μm (approximately 5, 3, or 2 mils).

In some embodiments it may be preferred that at least one of the layers comprise a third polymer wherein said third polymer comprises a polar or non-polar ethylene copolymer or a propylene copolymer, wherein said third polymer is characterized by having a modulus which is at least 10% less than the modulus of the first polymer.

It is preferred that the multilayer films of the present invention be formed in the blown film process as is generally known in the art, although other methods such as cast films, or lamination can be used.

To facilitate the improved physical properties of the multilayer films of the present invention, the multilayer film is subjected to a post-quench orientation step where the film is stretched at a temperature below the melting point of any polyethylene used in the film to a degree of from 1.1:1 to 3.5:1 in the machine direction or the transverse direction or both directions. In some embodiments the post-quench stretching is less than 3:1, 2.5:1, 2:1, or 1.5:1 in the machine direction, the transverse direction or both directions. In some preferred embodiments, the stretching is done in only one direction (that is, monoaxial orientation). In such cases, it may be preferred that the orientation be only in the transverse direction.

The stretching can be conducted using tenter frames or other methods which uniformly stretch the films. Alternatively, the films may be stretched by techniques which stretch the film in a non-uniform manner such that localized regions of the film remain unstretched. Such techniques include local stretching, interdigitized rollers or embossing techniques. It should be understood that with such localized stretching, the degree of stretching referred to above for some embodiments (that is from 1.1 to 3.5 to 1) refers to the stretch in the area which were subjected to the stretching and not the overall film.

The resulting films of the present invention can be characterized by their superior Tear Strength and Dart Impact. Tear Strength is measured by ASTM D-1922. Dart Impact is measured by ASTM D-1709. The films of the present invention will have Tear strength in the machine direction of at least 150 gm/mil and a Dart Impact of at least 150 gm/mil. In preferred embodiments, the MD Tear Strength is at least 200 gm/mil, or even 300 gm/mil. In preferred embodiments the Dart Impact is at least 200 gm/mil, or even 300 gm/mil. For purposes of these parameters the film thickness refers to the film post-quenching but prior to any stretching step to orient the film. Accordingly, the films of the present invention preferably have an MD Tear Strength measured after post-quench stretching of at least 150 gm/mil, 200 gm/mil, or 300 gm/mil thickness of the film prior to stretching. Similarly the films of the present invention preferably have a Dart Impact measured after post-quench stretching of at least 150 gm/mil, 200 gm/mil, or 300 gm/mil thickness of the film prior to stretching

### Additives

Additives that may be present in one or more layers of the multi-layer films of this invention, include, but are not limited to opacifying agents, pigments, colorants, slip agents, antioxidants, anti-fog agents, anti-static agents, anti-block agents, fillers, moisture barrier additives, gas barrier additives and combinations thereof. Such additives may be used in effective amounts, which vary depending upon the property required. Slip agents, antiblocking agents, anti-static agents, antioxidants and anti-fog agents are particularly effective when used in the outer layer(s) of the multilayer films of the present invention.

Pigments and colorants are typically added to polymers to impart opacity and, in some cases, particular color to the resulting films. Examples of pigments or colorants for use with the current invention are iron oxide, carbon black, colored pigments, aluminum, titanium dioxide (TiO₂), calcium carbonate (CaCO3), polybutylene terephthalate, talc, and combinations thereof. Colored pigments and colorants include agents that may be added to the polymer to impart any desired shade of color such as pink, blue, green, yellow, etc. Pigments and colorants may also contribute to the desirable optical qualities of the films of the current invention by imparting color and a pearlescent appearance that appeal to consumers.

Slip agents may include higher aliphatic acid amides, higher aliphatic acid esters, waxes, silicone oils, and metal soaps. Such slip agents may be used in amounts ranging from 0.05 wt % to 2 wt % based on the total weight of the layer to which it is added. An example of a slip additive that may be useful for this invention is erucamide.

Non-migratory slip agents, used in one or more skin layers of the multi-layer films of this invention, may include polymethyl methacrylate (PMMA). The non-migratory slip agent may have a mean particle size in the range of from 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAR™; (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX™ 1076 (commercially available from Ciba-Geigy Company of Switzerland) and phosphite anti-oxidants such as IRGANOX™ 168 (also commercially available from Ciba Geigy Company of Switzerland.) Such anti-oxidants are generally used in amounts ranging from 0.1 wt % to 2 wt %.

Anti-static agents may include alkali metal sulfonates, polyether-modified polydiorganosiloxanes, polyalkylphenylsiloxanes, and tertiary amines. Such anti-static agents may be used in amounts ranging from 0.05 wt % to 3 wt %, based upon the total weight of the layer(s).

Fillers and anti-blocking agents useful in this invention may include finely divided inorganic solid materials such as silica, fumed silica, diatomaceous earth, calcium carbonate, calcium silicate, aluminum silicate, kaolin, talc, bentonite, clay and pulp. Examples of suitable fillers and anti-blocking agents may include SYLOBLOC™ 44 (commercially available from Grace Davison Products of Colombia, Md.), PMMA particles such as EPOSTAR™; (commercially available from Nippon Shokubai Co., Ltd. of Japan), or polysiloxanes such as TOSPEARL™; (commercially available from GE Bayer Silicones of Wilton, Conn.). Such fillers and anti-blocking agents comprise an effective amount up to 3000 ppm of the weight of the layer(s) to which they are added.

Suitable moisture and gas barrier additives may include effective amounts of low-molecular weight resins, hydrocarbon resins, particularly petroleum resins, styrene resins, cyclopentadiene resins, and resin and terpene derived resins.

Optionally, one or more skin layers may be compounded with a wax or coated with a wax-containing coating, for lubricity, in amounts ranging from 1 wt % to 15 wt % based on the total weight of the skin layer. Wax-containing coatings may also be applied to an outer surface of a monolayer film. Any conventional wax, such as, but not limited to Carnauba™; wax (commercially available from Michelman Corporation of Cincinnati, Ohio), that is useful in thermoplastic films is contemplated.

The prepared films may be used in trash bags including kitchen trash bags, heavy duty garbage bags, leaf bags, trash can liners and other similar applications.

### Examples

In order to demonstrate the effectiveness of the organic voiding agents to prevent significant degradation in film performance and still allowing significant improvement in opacity on film deformation following films (examples 1-2) were prepared and evaluated. These films were made on a blown film line equipped with 70 mil die gap, 2.5 inch diameter die, 50 lb/hr output, ˜25 inch frost line height, 2.5 Blow Up Ratio (BUR) and ˜400 degree F. melt temperature.

Example 1 is a monolayer blown film with 0.9 mil thickness containing 95% LLDPE (1.0 dg/min Melt Index (2.16 kg load, 190 degree C.), 0.919 g/cc density) blended with 5% white color concentrate (50% Titanium Dioxide concentrate in LLDPE).

Example 2 is a monolayer blown film with 0.9 mil thickness containing 90% LLDPE (1.0 dg/min Melt Index (2.16 kg load, 190 degree C.), 0.919 g/cc density), 5% crosslinked acrylate beads (1.05 specific gravity) as a voiding agent, and 5% white color concentrate (50% Titanium Dioxide concentrate in LLDPE).

In order to understand the effect of inorganic voiding agent addition on film performance, films (examples 3-5) were made on Egan blown film line that is equipped with a 3 inch die and 2 inch (24:1 L/D) polyethylene screw. BUR of 2.5 was used a FLH of 12 inch was maintained. Melt temperature was close to 500 degree F.

Example 3 is a monolayer blown film with 1.0 mil thickness containing 100% LLDPE (1.0 dg/min Melt Index (2.16 kg load, 190 degree C.), 0.920 g/cc density).

Example 4 is a monolayer blown film with 1.0 mil thickness containing 95% LLDPE (1.0 dg/min Melt Index (2.16 kg load, 190 degree C.), 0.920 g/cc density) and 5% Calcium Carbonate.

Example 5 is a monolayer blown film with 1.0 mil thickness containing 95% LLDPE (1.0 dg/min Melt Index (2.16 kg load, 190 degree C.), 0.920 g/cc density) and 5% Kaolin Clay.

Physical properties of all 5 films were measured and are reported in table 1 and 2 below.

TABLE 1
Film properties for formulations without (example
1) and with (example 2) organic voiding agent.

| | Tensile | Tensile | Elmendorf | Dart |
|---|---|---|---|---|
| | break - MD | break - CD | Tear - MD | Impact |
| Sample ID | psi | psi | g/mil | g |
| Example 1 | 4953 | 3487 | 391 | 232 |
| Example 2 | 4785 | 3745 | 453 | 532 |

TABLE 2
Film properties for formulations without (example 3)
and with (examples 4 and 5) inorganic voiding agent.

| | Tensile | Tensile | Elmendorf | Dart |
|---|---|---|---|---|
| | break - MD | break - CD | Tear - MD | Impact |
| Sample ID | psi | psi | grams | grams |
| Example 3 | 8547 | 7241 | 263 | 290 |
| Example 4 | 6458 | 4928 | 136 | 295 |
| Example 5 | 5861 | 4322 | 180 | 230 |

From table 1 it is clear that addition of organic voiding agent does not deteriorate film performance as significantly as is observed on addition of inorganic voiding agent (table 2). This prevention of film performance degradation would allow one to make strong films even after stretching required to improve opacity.

All films were also hand stretched and the stretched portions were visually inspected and qualitatively graded for their opacity. Upon visual inspection, the deformed portion of the film containing the organic voiding agent appears significantly more opaque than the deformed portions in film without any voiding agent

Therefore use of organic voiding agent allows one to make films with higher opacity stretched regions without significantly degrading film performance.

The following embodiments are expressly considered to be part of the present invention although each embodiment may not be separately claimed.
1. A multilayer film suitable for use in liner applications, said multilayer film comprising:
   a. a first layer comprising a first polymer and at least one voiding agent, said first polymer comprising a polyethylene polymer having a density less than 0.940 g/cm³ and a melting point less than 130° C.;
   b. a second layer which is different than the first layer, said second layer comprising a second polymer, said second polymer comprising a polyethylene polymer having a density less than 0.940 g/cm³ and a melting point less than 130° C., wherein said second layer has less than 15% voiding agent, by weight of the second layer;
wherein said film has voids present in at least a portion of the first layer, said voided layer is non-porous, said voids are caused by combination of presence of voiding agent in the voided layer and uniform or localized stretching of the film, said voiding agent is organic in composition, and wherein said film after stretching has an MD Tear Strength of at least 150 gm/mil and a Dart Impact of at least 150 gm/mil.
2. The multilayer film of Embodiment 1 wherein the MD Tear strength is at least 150 gm/mil and the Dart Impact is at least 150 gm/mil.
3. The multilayer film of Embodiment 1 wherein the MD Tear strength is at least 150 gm/mil.
4. The multilayer film of Embodiment 1 wherein the MD Tear strength is at least 200 gm/mil.
5. The multilayer film of Embodiment 1 wherein the MD Tear strength is at least 250 gm/mil.
6. The multilayer film of Embodiment 1 wherein the Dart Impact is at least 150 gm/mil.
7. The multilayer film of Embodiment 1 wherein the Dart Impact is at least 200 gm/mil.
8. The multilayer film of Embodiment 1 wherein the Dart Impact is at least 250 gm/mil.
9. The multilayer film of Embodiment 1 wherein the second layer has no voiding agent.
10. The multilayer film of Embodiment 1 wherein the film is a blown film.
11. The multilayer film of Embodiment 1 wherein at least some of the voids have been formed by stretching at least a portion of the multilayer film to a degree of from 1.1:1 to 3.5:1 in one or both of the machine direction or the transverse direction, such stretching is conducted below the melting point of all polyethylene's used in the film.
12. The multilayer film of Embodiment 11 wherein the stretching in at least one direction is between 1.1:1 to 3:1
13. The multilayer film of Embodiment 12 wherein the stretching in at least one direction is between 1.1:1 to 2.5:1
14. The multilayer film of Embodiment 13 wherein the stretching in at least one direction is between 1.1:1 to 2:1
15. The multilayer film of Embodiment 14 wherein the stretching in at least one direction is between 1.1:1 to 1.5:1
16. The multilayer film of Embodiment 11 wherein the stretching is done only in one direction.
17. The multilayer film of Embodiment 11 wherein the film has been stretched uniformly.
18. The multilayer film of Embodiment 11 wherein the film has been stretched in a non-uniform manner such that localized regions remain unstretched while remaining regions are stretched to less than 3.5:1.
19. The multilayer film of Embodiment 18 wherein the film has been stretched using a local stretching technique.
20. The multilayer film of Embodiment 18 wherein the film has been stretched using an embossing technique.
21. The multilayer film of Embodiment 1 wherein the voiding agent is selected from the group consisting of polybutylene terephthalate, polystyrene, high impact polystyrene, polyamides, cyclic olefin polymers and copolymers, nylons, polyesters, acetals, acrylic resins, acrylic beads, crosslinked acrylic beads, crosslinked styrenic beads and combinations thereof.
22. The multilayer film of Embodiment 21 wherein the voiding agent comprises a material selected from the group consisting of polystyrene, polyacrylate, polyamide, cyclic-olefin copolymers, acrylate beads, crosslinked acrylate beads, crosslinked styrenic beads, high impact polystyrene and combinations thereof.
23. The multilayer film of Embodiment 21 wherein the voiding agent is high impact polystyrene.
24. The multilayer film of Embodiment 21 wherein the voiding agent is crosslinked acrylate beads.
25. The multilayer film of Embodiment 21 wherein the voiding agent is crosslinked styrenic beads.
26. The multilayer film of Embodiment 1 wherein the film comprises a color pigment.
27. The multilayer film of Embodiment 26 wherein the color pigment comprises titanium dioxide or carbon black.
28. The multilayer film of Embodiment 1 characterized in that it has a thickness of from 0.5 mil to 5.0 mil prior to any stretching step.
29. The multilayer film of Embodiment 27 characterized in that it has a thickness of from 0.7 mil to 3.0 mil prior to any stretching step.
30. The multilayer film of Embodiment 28 characterized in that it has a thickness of from 0.8 mil to 2.0 mil prior to any stretching step.
31. The multilayer film of Embodiment 1 wherein the voiding agent comprises from 1% to 20% by weight of the whole film.
32. The multilayer film of Embodiment 31 wherein the voiding agent comprises from 1.5% to 15% by weight of the first layer.
33. The multilayer film of Embodiment 31 wherein the voiding agent comprises from 1.5% to 10% by weight of the first layer.
34. The multilayer film of Embodiment 31 wherein the voiding agent comprises from 2.0% to 5% by weight of the first layer.
35. The multilayer film of Embodiment 1 wherein the filler on dispersion into the polymer has average particle size (d50) between 0.1 micron and 10 micron.
36. The multilayer film of Embodiment 1 wherein the filler on dispersion into the polymer has average particle size (d50) between 0.5 micron and 7 micron.
37. The multilayer film of Embodiment 1 wherein the filler on dispersion into the polymer has average particle size (d50) between 0.7 micron and 5 micron.
38. The multilayer film of Embodiment 1 wherein the filler on dispersion into the polymer has average particle size (d50) between 0.8 micron and 2 micron.
39. The multilayer film of Embodiment 1 wherein the filler on dispersion into the polymer has average particle size (d90) less than 5 times average particle size d50.
40. The multilayer film of Embodiment 1 wherein the filler on dispersion into the polymer has average particle size (d90) less than 3.5 times average particle size d50.
41. The multilayer film of Embodiment 1 wherein the filler on dispersion into the polymer has average particle size (d90) less than 2.0 times average particle size d50.
42. The multilayer film of Embodiment 1 wherein the first polyethylene polymer is a linear low density polyethylene copolymer having a density in the range of from 0.912 g/cm³ to 0.935 g/cm³.
43. The multilayer film of Embodiment 1 wherein the first polyethylene polymer is a linear low density polyethylene copolymer having a density in the range of from 0.915 g/cm³ to 0.930 g/cm³.
44. The multilayer film of Embodiment 1 wherein the first polyethylene polymer is a linear low density polyethylene copolymer having a density in the range of from 0.917 g/cm³ to 0.927 g/cm³.
45. The multilayer film of Embodiment 1 wherein at least one of the layers further comprises a third polymer wherein said third polymer comprises a polar or non-polar ethylene copolymer or a propylene copolymer, wherein said third polymer is characterized by having a modulus which is at least 10% less than the modulus of the first polymer.
46. The multilayer film of Embodiment 1 has one or more additional layers.
47. The multilayer film of Embodiment 39 wherein the film is configured such that the first layer is not a surface layer.
48. The multilayer film of Embodiment 1 further comprising one or more additives selected from the group consisting of slip agents, antiblocking agents, anti-static agents, antioxidants or anti-fog agents in at least the second layer.

It should be understood that various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

The invention claimed is:

1. A multilayer film suitable for use in liner applications, said multilayer film comprising:
a. a first layer comprising a first polymer and at least one voiding agent, said first polymer comprising a polyethylene polymer having a density less than 0.940 g/cm³ and a melting point less than 130° C.;
b. a second layer which is different than the first layer, said second layer comprising a second polymer, said second polymer comprising a polyethylene polymer having a density less than 0.940 g/cm³ and a melting point less than 130° C., wherein said second layer has less than 15% voiding agent, by weight of the second layer;
wherein said film has voids present in at least a portion of the first layer, said voided layer is non-porous, said voids are caused by combination of presence of voiding agent in the voided layer and uniform or localized stretching of the film, said voiding agent is organic in composition, and wherein said film after stretching has an MD Tear Strength of at least 150 gm/mil and a Dart Impact of at least 150 gm/mil.

2. The multilayer film of claim 1 wherein the MD Tear strength is at least 250 gm/mil.

3. The multilayer film of claim 1 wherein the Dart Impact is at least 250 gm/mil.

4. The multilayer film of claim 1 wherein the second layer has no voiding agent.

5. The multilayer film of claim 1 wherein the film is a blown film.

6. The multilayer film of claim 1 wherein at least some of the voids have been formed by stretching at least a portion of the multilayer film to a degree of from 1.1:1 to 3.5:1 in one or both of the machine direction or the transverse direction, such stretching is conducted below the melting point of all polyethylene's used in the film.

7. The multilayer film of claim 6 wherein the stretching is done only in one direction.

8. The multilayer film of claim 6 wherein the film has been stretched uniformly.

9. The multilayer film of claim 6 wherein the film has been stretched in a non-uniform manner such that localized regions remain unstretched while remaining regions are stretched to less than 3.5:1.

10. The multilayer film of claim 9 wherein the film has been stretched using an embossing technique.

11. The multilayer film of claim 1 wherein the voiding agent is selected from the group consisting of polybutylene terephthalate, polystyrene, high impact polystyrene, polyamides, cyclic olefin polymers and copolymers, nylons, polyesters, acetals, acrylic resins, acrylic beads, crosslinked acrylic beads, crosslinked styrenic beads and combinations thereof.

12. The multilayer film of claim 11 wherein the voiding agent comprises a material selected from the group consisting of polystyrene, polyacrylate, polyamide, cyclic-olefin copolymers, acrylate beads, crosslinked acrylate beads, crosslinked styrenic beads, high impact polystyrene and combinations thereof.

13. The multilayer film of claim 1 wherein the film comprises a color pigment comprising titanium dioxide or carbon black.

14. The multilayer film of claim 1 characterized in that it has a thickness of from 0.8 mil to 2.0 mil prior to any stretching step.

15. The multilayer film of claim 1 wherein the voiding agent comprises from 1% to 20% by weight of the whole film.

16. The multilayer film of claim 1 wherein the voiding agent comprises from 2.0% to 5% by weight of the first layer.

17. The multilayer film of claim 1 wherein the filler on dispersion into the polymer has average particle size (d50) between 0.1 micron and 10 micron.

18. The multilayer film of claim 1 wherein the filler on dispersion into the polymer has average particle size (d90) less than 5 times average particle size d50.

19. The multilayer film of claim 1 wherein the first polyethylene polymer is a linear low density polyethylene copolymer having a density in the range of from 0.917 g/cm³ to 0.927 g/cm³.

20. The multilayer film of claim 1 wherein at least one of the layers further comprises a third polymer wherein said third polymer comprises a polar or non-polar ethylene copolymer or a propylene copolymer, wherein said third polymer is characterized by having a modulus which is at least 10% less than the modulus of the first polymer.
